(19) United States
(12) Patent Application Publication
(10) Pub. No.: US 2011/0247958 A1
(43) Pub. Date: Oct. 13, 2011

(54) LIGHTWEIGHT UNIT LOAD DEVICE

(75) Inventors: Rick Lucas, Belmont, OH (US); Douglas Merriman, Wheeling, WV (US); Saundra McDonough, Verona, PA (US); Allan Tweddle, Carleston, WV (US)

(73) Assignee: Composite Transport Technologies ,Inc., Charleston, WV (US)

(21) Appl. No.: 13/124,447

(22) PCT Filed: Oct. 16, 2009
(86) PCT No.: PCT/US2009/061030

§ 371 Date: Jun. 28, 2011

Related U.S. Application Data
(60) Provisional application No. 61/105,813, filed on Oct. 16, 2008.
(60) Provisional application No. 61/179,573, filed on May 19, 2009.
(60) Provisional application No. 61/184,567, filed on Jun. 5, 2009.

(51) Int. Cl. B65D 90/00; B29C 70/52; B32B 7/02

(52) U.S. Cl. 206/524.6; 428/212; 264/164

(57) ABSTRACT

A unit load device constructed from fiber reinforced polymer matrix composite materials is described. Individual panels of the unit load device may be customized with composite materials and patterns. The joints are adapted to receive the ends of the panels of the unit load device and may further be customized with fiber reinforced composite materials to strengthen the joint. Some embodiments provide for construction of a unit load device from a variety of fiber reinforcing materials utilizing a matrix of thermoplastic polymers with similar softening temperatures. Each component part within the container was designed and/or created to address the specific needs of the particular part. The unit load devices described herein provide for all composite containers with a significant weight savings from conventional unit load devices.

### FIELD OF THE INVENTION

The present invention pertains to polymer composite materials useful for a variety of purposes, such as, for example, containers or load carrying containers. More particularly, the present invention pertains polymer composite materials that exhibit high strength to weight ratios that can be used to construct, for example, load carrying containers which are lightweight or other objects with walls that are high strength and light weight.

### BACKGROUND OF THE INVENTION

Within the airline industry it is a standard practice to compartmentalize the cargo which is to be carried on board the larger aircraft. This is done by separating the cargo into separate units and placing these units of cargo into individual containers which are commonly referred to as unit load devices (ULDs). Because of regulatory requirements, as well as practical considerations, the shape, size and maximum weight of a ULD for each type aircraft has been largely standardized.

Typically, ULDs are shaped as boxes which can include appropriately sloped surfaces that conform the ULD to the aircraft's fuselage when the ULD is placed in the aircraft's cargo compartment. Essentially, the container is made of several panels which are joined together to form the ULD and define an enclosed or partially enclosed volume. Additionally, each ULD has a door or an access hatch which allows it to be opened for placing cargo in the ULD or for removing cargo from the ULD. Often the ULD is constructed from a metal such as aluminum or an aluminum alloy. Materials such as aluminum are able to tolerate the tough handling conditions the container experiences through transfer and transport stations.

ULDs constructed from composite materials have been utilized in areas to mitigate the effects of an explosion. These composite containers use very thick walls and joints to provide strength against an explosive force and/or require use of a secondary packaging step such as packaging the contents in a mylar bag which is placed inside the container. The side effect of these containers is that they typically do not provide any significant weight savings over their aluminum ULD counterparts.

Other composite ULD containers are formed or molded from a common composite material without regard to the different sections or portions of the ULD container. Additional ULD containers utilize a metal framework with composite panels inserted within the metal framework.

### SUMMARY OF THE INVENTION

Embodiments of the invention are directed to utilization of polymer composite materials in the construction of containers or structures. Embodiment of the present invention are directed to a ULD utilizing a variety of different fibers embedded in one or more a polymer matrices at different locations or regions of the ULD. Additional embodiments may include similar reinforcement materials provided in different forms such as woven fibers, unidirectional fibers, continuous fibers, chopped fibers, and/or particulates in varying quantities at different regions of the ULD.

Certain embodiments of the invention are directed to a ULD constructed from polymer composite materials which is lighter than a corresponding ULD constructed from aluminum, or other molded polymer composite containers, yet still conforms to the strength requirements set for a ULD.

In some embodiments, a ULD is constructed from a series of panels and joints in which the panels are constructed from various polymer matrix composite materials to achieve a weight reduction between about 25% and about 50%, in some embodiments at least about 25%, in other embodiments at least about 40%, and in still further embodiments at least about 50%, when compared to the tare weight for a ULD as provided the International Air Transport Association (IATA) ULD Technical Manual.

The demands of each component part of the container were evaluated and materials were selected and in multiple cases created to address the specific needs of the component part. In addition, the physical requirements each part was created to have a low weight to high strength ratio and low cost.

The techniques described herein can provide advantageous cost savings, amongst the various advantages possible. For example, the techniques and materials used to provide the corner joints from carbon fibers and resin can be used to produce light weight, high strength materials suitable for numerous applications. For example, as is understood in the transport industries, such as cargo transport, people transport (e.g., passenger airlines, trains, buses, cars, ships) and motor vehicles generally, a reduction in weight typically results in a reduction in fuel consumption, which will provide costs savings. Cost savings will be advantageous to the owner or operator of the cargo transport service, people transport service or motor vehicle. Some embodiments include a container comprising a plurality of polymer composite wall panels connected together by a plurality of polymer composite joints and defining at least a partially enclosed volume, wherein the plurality of polymer composite wall panels comprise a core of a first polymer composite material and a polymer composite surface layer of a second polymer composite material bonded to opposing surfaces of the core, and wherein the second polymer composite material exhibits an elastic modulus lower than that for the first polymer composite material. The container may include a first polymer composite material selected from the group consisting of a carbon fiber reinforced composite material and a glass fiber reinforced composite material. The container may include a second polymer composite material that is a polymer fiber reinforced composite material having reinforcing fibers selected from the group consisting of polyethylene, polypropylene, aramid, TEGRIS, and KEVLAR. In some embodiments, the container may exhibit a weight to volume ratio ranging from about 0.6 lbs/ft³ to about 0.8 lbs/ft³. In further embodiments, the container may include an aircraft cargo LD-3 container and exhibit a ratio of container tare weight to FAA certification load of 0.02 to about 0.03 relative to the IATA, 23^{rd} Edition, Effective Jul. 1, 2008. In some embodiments, polymer composite wall panel of the container may exhibit weight ranging from about 0.1 to about 0.2 lbs/ft². Further, in additional embodiments, the container may include polymer composite joints comprising a fiber reinforced composite material having reinforcing fibers selected from the group consisting of carbon fibers. aramid fibers, KEVLAR, and glass fibers. The composite joints may comprise carbon fiber reinforce composite material, and wherein the composite joint exhibits a fiber volume fraction ranging from about 60% to about 70%.

Further embodiments of the invention may include a polymer composite wall panel comprising a core of a first polymer composite material and a polymer composite surface layer of a second polymer composite material bonded to opposing surfaces of the core, and wherein the second polymer composite material exhibits an elastic modulus lower than that for the first composite material. The polymer composite wall panel may include a configuration of core composite material that is a carbon fiber reinforced composite material and is bonded on both sides by the second composite material is a polymer fiber reinforced composite with polypropylene reinforcing fibers and has higher impact strength than a aluminum sheet of similar weight. The polymer composite wall panel may further include alternating layers of first polymer composite material and second polymer composite material.

Still further, embodiments of the invention may include a method for making a composite part comprising the steps of, in a continuous process, pulling carbon fibers coated with polyether soft segment aliphatic isocyanate sizing through a supply of polyurethane to provide polyurethane impregnated carbon fibers; and shaping the polyurethane impregnated carbon fibers to a predetermined size and forming a carbon fiber reinforced polyurethane material, wherein the fiber volume fraction ranges from about 60% to about 70%.

In further embodiments may include a substantially polymer composite container comprising a plurality of polymer composite wall panels comprising carbon fibers joined together by a plurality of polymer composite joints comprising carbon fibers and defining at least a partially enclosed volume, the polymer composite wall panels and joints being positioned on a polymer composite base; and one or more mechanical fasteners to retain the wall panels to the joints and the joints to the base, wherein the substantially polymer composite container has a weight reduction of at least 50% in comparison to an aluminum container of a similar dimension and volume. Mechanical fasteners may include one or more of bolts, screws and rivets. The mechanical fasteners may comprise a metal material.

### BRIEF DESCRIPTION OF THE DRAWINGS

FIG. 1 is a perspective view of a unit load device in accordance with an embodiment of the invention.

FIG. 2 is a cross-sectional representation of a unit load device as seen along the line 2-2 in FIG. 1 with portions of the device removed for compactness and clarity in the Figure.

FIG. 3 is a cross-sectional representation of a joint in accordance with an embodiment of the invention.

FIG. 4 is a cross-sectional representation of a polymer composite wall panel in accordance with an embodiment of the invention.

FIG. 5 is a perspective view of a second corner joint that can be formed by pultrusion.

### DESCRIPTION OF THE PREFERRED EMBODIMENT

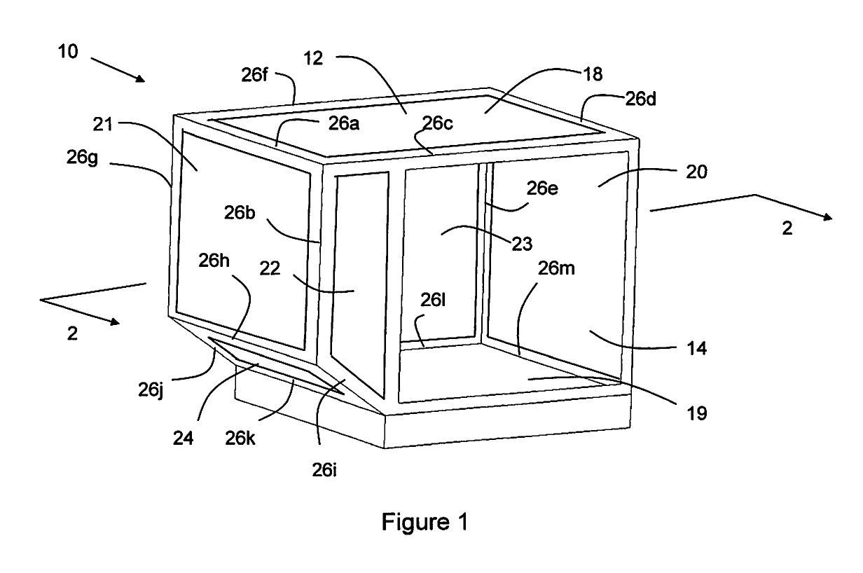

Embodiments of the present invention may generally be applicable to containers or structures utilizing walls to define an enclosed or partially enclosed volume. Referring initially to FIG. 1, an embodiment of a unit load device (ULD) is shown and is generally designated by the reference numeral 10. As seen in FIG. 1, ULD 10 includes a container 12 which is formed with an opening 14. Although the actual size and configuration of the ULD 10 can be varied to meet specified space requirements, the particular configuration shown in FIG. 1 is readily adaptable for use with most aircraft. The ULD 10 has a box-like shaped container 12 that is constructed using a plurality of substantially flat panels and define an enclosed volume or space for holding cargo, luggage, packages, or other items for transport. For ULD 10, the top panel 18, bottom panel 19, right side panel 20, left side panel 21, front panel 22, back panel 23, and sloped panel 24 are exemplary. These, and the other panels which are necessary to create container 12, are connected to each other using a plurality of joints represented by joints 26 a, b, c, etc. along their respective peripheries where the panels intersect each other. While the embodiment illustrated in FIG. 1 shows a container with substantially flat walls, other embodiments may also include one or more curved or shaped wall panels.

Importantly, the materials used for the construction of container 12 should exhibit a very high strength to weight ratio and offer high impact strength, chemical and water resistance, and relatively low flammability and off-gas emissions. In certain embodiment, and in particular for aircraft container transport applications, the materials for the container preferably exhibit a thermal stability over a −55° C. to 75° C. use temperature. However, different regions of the container may experience different demands. Not all components of the container need to be constructed of the same material to account for the different demands. For example, the polymer composite wall panels should be constructed from one or more materials that have a low density yet exhibits good impact strength and flexural strength. The polymer composite wall panels should exhibit a very high strength to weight ratio and offer high impact strength, thermal stability, chemical resistance and relatively low flammability and off-gas emissions. Typical container walls have been made from metals such as aluminum or aluminum alloys, plastics, and fiberglass. It has been found that weight and strength advantages are obtained by using particular combinations of fiber reinforced polymer composite materials to form the walls of a container. As will be discussed below, in certain embodiments, one or more walls of the container may include at least two different fiber reinforced polymer composite materials laminated together in which one fiber reinforced polymer composite forms a core and at least one other fiber reinforced polymer composite material forms polymer composite surface layers positioned over opposing surfaces of the core.

In certain embodiments, one or more of the polymer composite wall panels of a container may be constructed from multiple layers of polymer composite materials in a laminated or sandwich style configuration having a core of a first polymer composite material and polymer composite surfaces layers of a second polymer composite material bonded to opposing surfaces of the core either directly or through the use of an adhesive layer or tie layer. In certain embodiments, the polymer composite surface layers comprise a second polymer composite material that is more ductile and has an elastic modulus lower than the first polymer composite material making up the core. In further embodiments, one or more layers of polymer composite materials may be alternated through the thickness of the polymer composite wall panel, however, the more ductile and lower modulus material is positioned on the outer surfaces of the polymer composite wall panel.

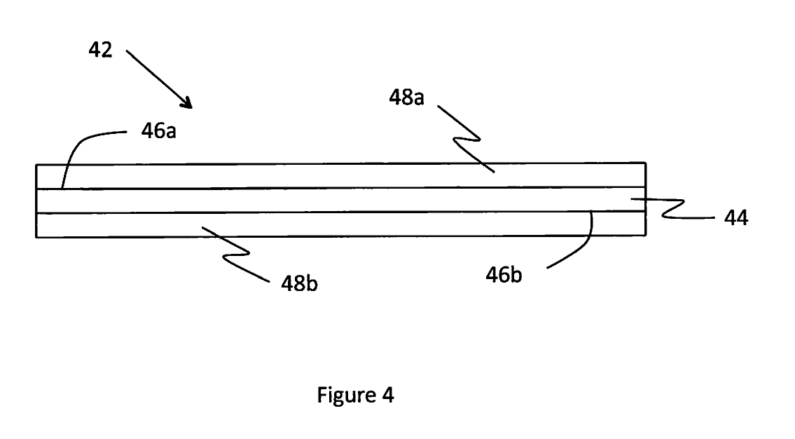

Turning now to FIG. 4, there is illustrated an embodiment of a polymer composite wall panel 42 in accordance with an embodiment of the invention. The polymer composite wall panel 42 may include a core 44 having opposing surfaces 46a and 46b. Polymer composite surface layers 48a and 48b are bonded to opposing surface 46a and 46b respectively either directly or through the use of an adhesive layer or tie layer.

In certain embodiments, the polymer composite material used for the core 44 and/or the surface layers 48a and 48b may be formed from fiber reinforced polymer matrix composite materials in which reinforcing fibers are embedded in or otherwise immobilized in a polymer matrix. In some embodiments, the reinforcing fibers for the polymer matrix composite may include, but are not limited to, aramid fibers, KEVLAR fibers, carbon fibers, glass fibers, high strength polymer fibers, or combinations thereof. The reinforcing fibers may be in the form of woven fibers, unidirectional fibers, continuous fibers, chopped fibers, whiskers, and/or particulates in varying quantities. In some embodiments continuous fibers may be used and oriented in predetermined configurations.

The polymer matrix material should be a material that is compatible with the selected fiber or fiber combination. Other considerations for the polymer matrix material, depending upon the intended use for the container, may include the weight of the polymer matrix material, the bond strength with the embedded fibers, and exhibit good impact and wear resistance. In application where the container will experience significant changes in temperature, such as, for example, for a ULD, the ability of the polymer composite material to withstand thermal cycling between about −55° C. and about 75° C. may be important. In some embodiments, the polymer matrix for the polymer matrix composite may include, but is not limited to, polypropylene, polyester, epoxy, polyurethane, cyanate esters, PEEK, and PPS. In some embodiments the polymer composite material may include a fiber reinforced polymer composite material commercially available as TEGRIS™ from Milliken Co. In some embodiments, the polymer composite wall panel exhibits weight ranging from about 0.1 to about 0.2 lbs/ft²

In particular embodiments, the core 44 may include a fiber reinforced polymer composite material that has been derived from one or more layers of a carbon fiber reinforced prepreg material utilizing carbon fibers in a thermoset polymer matrix. The thermoset polymer matrix may include but is not limited to epoxy resins or vinyl ester resins. The carbon fibers in the prepreg may include continuous or woven carbon fibers. One exemplary carbon fiber may include, but is not limited to, Toho Tenax HTS 40 F13 12K 800 tex., with a tensile strength of 670 ksi, modulus of 34.7 Msi, and density of 1.77 g/cc. Exemplary carbon fiber prepregs may include, but are not limited to Hexcel's HexPly MI OE epoxy resin system preimpregnated into graphite multiaxial fabric.

In another particular embodiment, the core 44 may include fiber reinforced polymer composite material that has been derived from one or more layers of a glass fiber reinforced prepreg material utilizing a glass fibers in a thermoset polymer matrix. The thermoset polymer matrix may include but is not limited to epoxy resins, vinyl ester resins, or phenolics. The glass fibers in the prepreg may include continuous or woven glass fibers. Further the glass fibers may include, but are not limited to, S-glass or E-glass fibers. Exemplary glass fiber prepregs may include, but are not limited to Hexcel's F155 a modified epoxy formulation preimpregnated into a MIL-C-9084 glass weave.

With continuing reference to FIG. 4, the core 44 includes opposing surfaces 46a and 46b. Polymer composite surface layers 48a and 48b are bonded to core surfaces 46a and 46b. In certain embodiment, the polymer composite surface layers comprise a surface material that is more ductile than the core material and has an elastic modulus lower than that for the core material.

The polymer composite surface layers may comprise a polymer fiber reinforced composite material. The polymer fiber reinforced composite includes a plurality of polymer fibers embedded in or otherwise immobilized by a polymer matrix. The polymer fiber reinforced composite material may be formed from one or more layers of a polymer fiber reinforced polymer material. The polymer fiber reinforced polymer material is a material that when heated produces a polymer fiber reinforced composite. A polymer fiber reinforced polymer material may include, but is not limited to, polymer fiber prepreg materials as well as woven or braided polymer fiber materials in which at least a portion of the polymer fibers melt and immobilize the other polymer fibers upon heating. The polymer fiber reinforced polymer material includes a plurality of polymer fibers associated with a thermoplastic polymer material. Upon curing of the polymer fiber reinforced polymer material, the polymer fibers are substantially immobilized by the thermoplastic polymer. The thermoplastic polymer thus forms a polymer matrix holding the polymer fibers in a substantially fixed relationship to one another.

The polymer fiber reinforced composite material forming the polymer composite surface layers includes a plurality of polymer fibers immobilized in a polymer matrix. In some embodiments the fiber reinforcements of the surface layer may be in the form of fibers, tapes, or yarns. The reinforcing fibers may be in the form of a woven fabric, unidirectional or multidirectional fibers. In some embodiments, continuous fibers may be oriented in predetermined configuration such as 0° and 90° or other relative angles between one another.

The reinforcing fibers may include, but are not limited to, polyethylene, polypropylene, aramid, KEVLAR, high strength polymer fibers, or combinations thereof. The polymer matrix material should be a material that is compatible with the selected fiber or fiber combination. Other considerations for the polymer matrix material, depending upon the intended use for the container, may include the weight of the polymer matrix material, the bond strength with the embedded fibers, and exhibit good impact and wear resistance. In application where the container will experience significant changes in temperature, such as, for example, for a ULD, the ability of the polymer composite material to withstand thermal cycling between about −55° C. and about 75° C. may be important. In some embodiments, the matrix material for the polymer matrix composite may include, but is not limited to, polyethylene, polypropylene, polyurethane, polyester, epoxy, cyanate esters, PEEK (polyether etherketone), and PPS (polyphenylene sulfide). In certain embodiments, the polymer fiber reinforced polymer material that may be used to form the surface layers include, but are not limited to, TEGRIS from Milliken Co., which utilizes a polypropylene fiber in conjunction with a polypropylene matrix. Additional embodiments for the polymer composite surface layers may include fiber reinforced polymer hybrid fibers such as those available from Polystrand® Inc. which combines continuous structural E-Glass, S-Glass and Aramid fibers oriented matrix of thermoplastic polymers.

In some embodiments a first polymer composite surface layer may be attached or bonded to one surface of the core while a second polymer composite surface layer may be attached or bonded to an opposite surface of the core. The first and second polymer composite surface layers may be the same polymer composite material or different polymer composite materials.

To construct the wall panel in accordance with an embodiment of the invention, the selected fiber reinforced polymer composite prepreg layers to be used to form the core of the wall panel are laid-up together. The number of fiber reinforced polymer composite prepreg layers making up the core may range from about 1 layer to about 20 layers, in other embodiments the number of fiber reinforced polymer composite prepreg layers may range from about 1 to about 10 layers, and in further embodiments, range from about 1 to about 5 layers. In certain embodiments, the fiber reinforced polymer composite prepreg layers may include the above referenced polymer composite materials for the core and may specifically include but is not limited to carbon fiber composite prepreg layers or glass fiber composite prepreg layers.

The polymer composite surface layers are prepared by laying up the desired number of polymer fiber reinforced polymer material over the surfaces of the fiber reinforced polymer composite making up the core. In some embodiments, each polymer composite surface layer may be constructed from about 1 to about 10 layers of polymer layers, other embodiments may range from about 1 to about 5 layers of polymer layers. An adhesive layer or a tie layer may be used to assist in the bonding of surface layers to the core. This is particularly advantageous for bonding generally thermoset polymers to thermoplastic polymers. Selection of materials and process parameters that enables the ability to bond a polypropylene thermoplastic material to a carbon fiber thermoset material and co-cure in a single process step offering a unique material fabricated with a cost saving process

In some embodiments multiple layers of the surface and core may be sequenced to improve the impact and ballistics resistance of the panel while improving the strength. For example, two layers of woven polypropylene matrix, then two layers of a carbon prepreg, then to two layers of the woven polypropylene matrix, then two layers of the carbon prepreg, then two layers of the woven polypropylene matrix, would offer improved breakthrough resistance than a four layer carbon core bounded by three layer woven polypropylene matrix on both sides.

In the case of carbon fiber or glass fiber prepreg materials, these materials for the core may be cured together with the polymer surface layers or separately. In order for the carbon fiber or glass fiber prepreg for the core to be cured together with the polymer surface layers, the cure temperatures for each of the respective polymer composite layers should be similar enough to allow for a single curing step. If the difference in the cure temperatures between the prepreg materials for the core and the polymer material for the surface layers is too great, they should be cured in separate curing steps or stages. The laid up structure may be cured at appropriate temperatures for the selected materials using standard techniques known to those skilled in the art.

As discussed above, the materials making up the core may include a polymer matrix that is a thermoset resin while the materials for surface layers utilize polymers, such as polypropylene, that may be thermoplastic. In this situation, it can be advantageous to have a carbon fiber or glass fiber prepreg material that has a cure temperature similar to the polymer composite material thereby expanding the use temperature over the thermoplastic surface layer alone.

A particular embodiment of the present invention may include a carbon fiber reinforced epoxy prepreg having a cure temperature near 300° F. for the core and two layers of TEGRIS as the polymer fiber reinforced polymer material for the surface layers over opposing surfaces of the carbon fiber reinforced epoxy prepreg. A tie layer or adhesive layer may be used between the surfaces of the carbon fiber reinforced epoxy prepreg and the surface of the TEGRIS material to assisting in bonding the polypropylene weave (TEGRIS) to the epoxy resin of the carbon fiber epoxy prepreg. The entire lay up may be cured together at about 300° F. and at about 100 psi.

These materials can be used to make a very thin, strong, and lightweight panel. Certain embodiments may include a core produced from a single carbon fiber prepreg layer having a single layer of TEGRIS composite material on opposing surfaces of the core. Such a configuration may exhibit a weight of about 0.16 lbs./ft.², a tensile strength ranging from about 20 to about 40 ksi, and a modulus ranging from about 1.5 to about 4 Mpsi.

This configuration exhibited enhanced fire protection properties when compared to each material separately. The burn rate for a section of a wall panel having a carbon fiber reinforced composite core with surface layers made from TEGRIS exhibited a slower burn rate than for the carbon fiber reinforced composite material or the TEGRIS material separately. Further, by having the carbon fiber reinforced composite at the core of the panel, and the polypropylene fiberous material on the surface layers will primarily absorb an impact and contain the carbon fibers within the panel even if the carbon fibers fracture, thus reducing the breakthrough penetration potential of an impact.

In addition to improved fire protection properties, the carbon fiber reinforced epoxy prepreg core bounded by the TEGRIS material on both surfaces of the core offers improved impact strength and shape memory. More specifically, an aluminum sheet material of comparable strength or weight will exhibit permanent localized areas of deformation “denting” in the areas of blunt impact. However, the polymer composite wall panel described above subjected to the same blunt force impact will show little visible evidence, if any, of damage. The polymer composite wall panel generally maintains an unblemished appearance.

Certain embodiments for a polymer composite wall panel include a core made from a layer of a carbon fiber prepreg material and a surface layer of polypropylene composite material bonded to opposing surfaces of the core. The polypropylene composite material may include TEGRIS.

Not all wall panels for a container must be constructed from the same materials or using the same amount of materials. It is expected that for some containers, different regions of the container experience different demands or different container sizes may require stiffer panels. To account for the different demands in different regions of the container or different container sizes, the amount and/or types of the materials making up the core and surface layers may be varied to get the desired properties needed to accommodate the particular demand in that region of the container.

As between each polymer composite wall panel, the panels may be constructed from the same polymer composite materials or one or more panels may be constructed from different polymer composite materials, For example the right side panel 20, left side panel 21, front panel 22, back panel 23 are all side panels oriented in a generally vertical orientation. Desirable characteristics for these panels include being light weight, resistant to impact, high strength and stiffness, and durable.

Further, as the size of the container increases, the size of one or more the panels will increase and the distance the panel has to span will increase. To aid in stiffening the panel to span the distance, grid stiffeners may be molded into the surface of the panel. The pattern of the molded grid stiffeners is not particularly limited and may include as series of orthogonal corrugations formed across the panel. In some embodiments the corrugations may form a series of triangles, diamonds, or other geometric shapes.

The bottom panel 19 may experience more abrasive forces than the other panels of the container. In some embodiments, the bottom panel 19 may be constructed of KEVLAR, carbon, glass, or boron fibers embedded in a polymer matrix. In some embodiments, the polymer matrix for the bottom panel 19 may include, but is not limited to, polyethylene, polypropylene, polyester, epoxy, polyurethane, cyanate esters, PEEK, and PPS. In some embodiments, the selected polymer matrix composite for the bottom panel 19 should exhibit high flexural strength, high resistance to deformation under load, and exhibit good abrasion resistance.

If desired, to aid in lowering the coefficient of friction or wear rate for the bottom panel 19, additional materials may be added to the matrix material used in forming the bottom panel 19. The additional materials may include, but are not limited to, graphite, poly(tetrafluoroethylene) (PTFE), or molybdenum disulfide, and high wear polymer composite materials such as ultra-high molecular weight polyethylene.

In some embodiments, the bottom panel of the container may include a bumper around the perimeter of the bottom panel or base of the container. In one embodiment, an ultra high molecular weight polyethylene (PE) may be used for a container bumper around the base of the container because of its low coefficient of friction, low weight and relatively low cost, high impact strength, weather-ability as well as other material properties that make it a good candidate material to address the specific need of a container bumper. Further the ultra high molecular weight polyethylene may be used on wear surfaces of the container

The theme on design and tailoring the materials and process to the needs of the specific component part were exemplified with the container base. The container base may be designed to address the needs of the part but the materials were modified through the thickness. The materials changed across the thickness to address the specific location needs.

In some embodiments the base of the container may include a lightweight core material surrounded by polymer composite materials described above. A bumper as described above may be positioned around perimeter of the base of the container.

In some embodiments, a Peel Ply maybe used on the top surface to create a non-slip surface to aid loaders walking over the container floor. Further a FireStop Scrim-BG34 3JJ1524 (L100) can be added beneath the surface imbedded within the resin to inhibit the progression of fire within the cargo contained within the airfreight container. The material also provides a barrier to the carbon fiber below to prevent carbon environment contamination in the aircraft. The fire stop material can be substituted with 7500 fiberglass. This also provides a barrier to the carbon fiber and provides a low cost to strength benefit. Next, two layers of 410 gsm +45/_{—}45 carbon fabric may be placed 90° relative to each other to provide a low weight, high strength benefit with fiber axis located in 4 directions to generate more uniform properties from the carbon fiber. A foam core may be added to rigidity. Rigidity in the core is important because it adds in reducing abrasion wear of the assembly. In this lay-up Divinycel foam was used for both its rigidity and process-ability and compatibility with the adjacent materials and thereby reducing processing issues with some other core options. On the bottom side three layers of Kevlar fabric was used because of its high strength to weight ratio and impact resistance and strength which is a concern for the handling of airfreight containers which experience scratching and sharp point loads from damaged rollers and aircraft clamps. The resin on the lower wear surface was designed to have a very smooth surface finish so that it has a low coefficient of friction and yields glide and slide across roller bearings easier that the current aluminum aircraft containers.

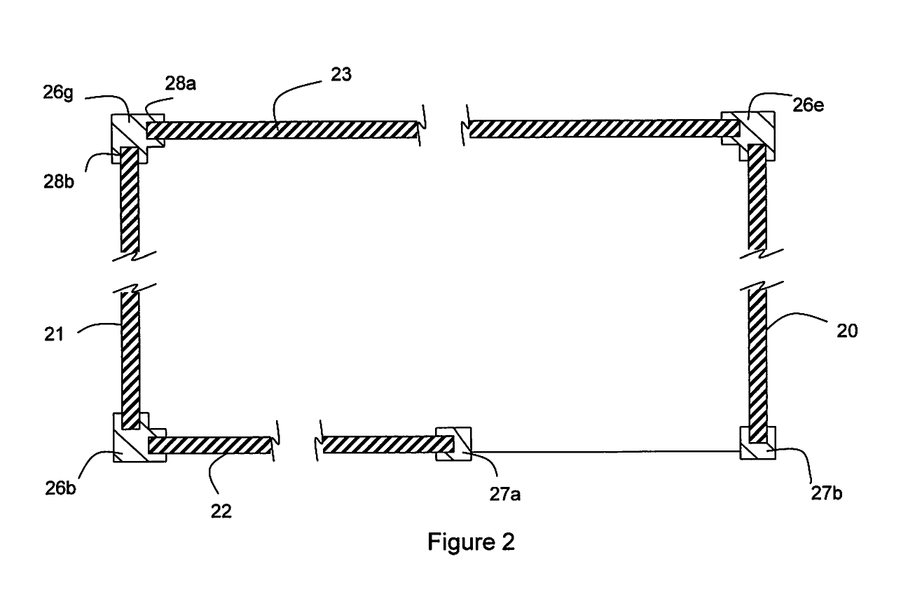

Other materials can be substituted for each of these materials. For example, the inventors used phenolic foam core in the lay-up in lieu of the Divinycel to improve the fire performance of the core. In another lay-up the inventors substituted Nexcore by Millikin to improve the rigidity and strength that will be needed for larger aircraft container sizes such as the AMJ.

Where the edges of the panels come together a joint is formed. The joint will have increased strength requirements as compared to the panels. In some embodiments, the joint will require a higher modulus of elasticity than the panels. In some embodiments, the joints will be the major load bearing component of the container. With reference to FIG. 2, a joint 26b, 26g, and 26e are shown connecting panels 20, 21, 22, and 23. In certain embodiment, the joints may be made from fiber reinforced polymer matrix materials with continuous fibers and multi-directional fabrics as the reinforcing fibers. In certain other embodiments the matrix material may include any of the matrix materials described above and the reinforcing fibers may include, but are not limited to, carbon fibers. aramid fibers, KEVLAR, glass fibers, or combinations thereof. Further the reinforcing fibers may include a combination of different fibers comprising one or more of the above listed fibers. In addition, a composite surfacing veil may be imbedded to add additional properties. End cap joints 27a and 27 b are illustrated on the ends of panels 22 and 20 respectively. The end cap joints may be construct of any of the materials used to form the joints for the container as previously discussed. In certain embodiments, wear surfaces including, but not limited to, end caps, bumper and lower base plate of airfreight containers will contain as little amount of carbon fibers on the outer surface as possible to prevent carbon environment contamination. Therefore, in certain embodiments, the wear surfaces of the container will not contain carbon fibers in the outer surface of these members.

Each of the joints may have at least one groove adapted to receive an end of a panel. In FIG. 2, the joint 26g includes a groove 28a sized to receive an end of panel 23 and another groove 28b sized to receive an end of panel 21. The groove may be sized such that a tight fit between the groove and panel are formed. In some embodiments, the groove may be sized to allow for thermal expansion and contraction of the end of the panel without losing the structural integrity of the connection between the joint and the panel. In further embodiments, adhesives and/or mechanical fasteners such as rivets may be used to secure the end of the panel within the groove of the joint. In other embodiments, the ends of the panel may include a snap lock connection; such as, a series of angled teeth formed on opposing surfaces near the end of the panel. The walls of the groove in the joint may include angled teeth on the surfaces of the walls that are oriented opposite the direction of the angled teeth near the ends of the panel. Sliding the end of the panel into the joint will produce an interlocking engagement between the panel and the joint.

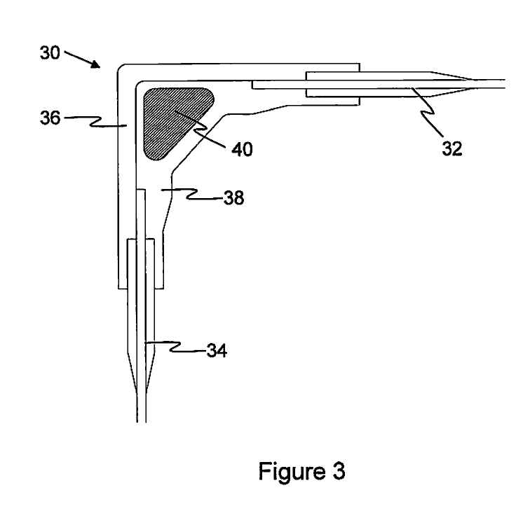

With reference to FIG. 3, there is illustrated another joint 30 for a container in accordance with another embodiment of the invention in mating connection with panel 32 and panel 34. The joint 30 is shown using a hybrid fiber composite construction in which the outer portion 36 of the joint 30 is a fiber reinforced polymer matrix composite which can be made from any of the previously described fibers and matrix materials described above for the container joint. In some embodiments, the outer portion 36 may be tailored to provide for increased more impact strength. In certain embodiments, the reinforcing fibers may be continuous fibers embedded in the polymer matrix. The matrix material for the outer portion 36 may include, but is not limited to, include, but is not limited to, polyethylene, polypropylene, polyester, epoxy, polyurethane, cyanate esters, PEEK, and PPS.

In some embodiments, the internal portion 38 of the joint 30 may include a carbon fiber or glass fiber reinforced polymer matrix composite material. The fibers may be continuous fibers or chopped fibers. The matrix material for the internal portion 38 may include, but is not limited to, any of the above described polymer matrix materials.

In some embodiments, the internal portion 38 may include an optional embedded core material 40, which may include, but not limited to, balsa wood, a polymeric foam, such as a phenolic foam, Divinycell, or a carbon foam such as CFOAM® by Touchstone Research Laboratories. In some embodiments, the foam may include fire-prevention properties. In some embodiments, the outer portion 36 and internal portion 38 of the joint 30 may be pultruded or molded from the selected materials. Optionally, the core material may be omitted from the construction in certain regions of the joint or entirely resulting in a void space extending along the length of the joint 30. In the area of the internal portion 38 of the joint 30 in which the core material has been omitted, one or more sensors may be placed in the resulting cavities. Such sensors may include, but are not limited to sensors for temperature, humidity, stress, or content identification.

In certain embodiments, the polymer matrix used for the joint and the panels may be a thermoplastic material having similar softening temperatures. By constructing the joint and the panels using thermoplastic polymers having similar softening temperatures, the ULD may be constructed and heated to a temperature sufficient to result in the polymers softening and melding together to form a cohesive bond between the joint, including any outer portions and inner portions, and the panels. This may allow for the ULD to be assembled and heated to create a polymer composite ULD utilizing different fibers strategically placed in particular areas with an essentially homogenous polymer matrix. Further, this technique may provide for producing a water tight seal between the joints and the panels of the ULD.

In some embodiments the joints may be metal or polymer extruded joints. In other embodiments the wall panel may be used to replace existing metal, aluminum, or plastic walls of existing containers.

In some embodiments, the container may include a unit load carrying device and is constructed from a series of panels as described above and joints in which the panels are constructed from various polymer matrix composite materials to achieve a weight reduction between about 25% and about 60% over an equivalent size aluminum alloy container, in some embodiments at least about 25%, improvement over the recommended tare weight for a ULD as provided the International Air Transport Association (IATA) ULD Technical Manual.

In some embodiments, the container may include a unit load carrying device and is constructed from a series of polymer composite wall panels and composite joints as described above and achieves a weight to volume ratio ranging from about 0.6 lbs/ft³ to about 0.8 lbs/ft³, and in other embodiments from about 0.6 lbs/ft³ to about 0.7 lbs/ft³, and in yet other embodiments about 0.67 lbs/ft³. Further, the container may exhibit in some embodiments, a ratio of a container tare weight to FAA (Federal Aviation Administration) certification load of 0.02 to about 0.03 relative to the IATA, 23^{rd} Edition, Effective Jul. 1, 2008. In particular embodiments, the container is constructed from a plurality of polymer composite wall panels connected together through composite joins as described above, achieves a weight to volume ratio ranging from about 0.6 lbs/ft³ to about 0.8 lbs/ft³ and exhibits a ratio of container tare weight to FAA certification load for a given container of 0.02 to about 0.03. The FAA certification load is a standard indicated in the International Air Transport Association (IATA) ULD Technical Manual. For example, an LD-3 container includes a volume of 150 ft³ and is required to contain and support a 3500 lb load. In some embodiments, an LD-3 container made in accordance with the present invention may exhibit a tare weight of about 90 lbs and is able to contain and support a 3500 lb load. This provides a weight to volume ratio of about 0.6 lbs/ft³ and a ratio of container tare weight to FAA certification load of about 0.26.

The corners or joints used in the ULDs may be constructed by pultrusion. Pultrusion is a continuous, automated closed-molding process that can be used for making constant cross section parts, such as a corner joint for a ULD. Due to uniformity of cross-section, resin dispersion, fiber distribution and alignment, excellent polymer composite structural materials can be fabricated by pultrusion.

The typical pultrusion process begins by pulling reinforcing fibers from a series of creels and then through a creel card. The fibers then proceed through an injection box or a bath, where they are impregnated with a blend of formulated resin and an optional catalyst. The resin-impregnated fibers are pre-formed to the shape of the profile to be produced by pulling the resin-impregnated fibers through a pre-forming fixture where the section is partially pre-shaped and excess resin is removed. The fiber-resin material then is passed through a heated die, which imparts the sectional geometry and finish of the final product. The die is machined to the final shape of the part to be manufactured, however, the die shape may be slightly larger or smaller than the desired part shape to account for part shrinkage or expansion during the process. Heat can be used to initiate or accelerate an exothermic reaction thereby curing the thermosetting resin matrix. The profile is continuously pulled and exits the mold as a hot, constant cross sectional member. The profile cools in ambient or forced air, or assisted by water and then passes through a puller mechanism and is cut to the desired length by an automatic, flying cutoff saw, or other cutting device. Additives may be added to the resin to improve the material properties or part features. For example, adding thermoplastic granuals can improve impact strength and reduce crack propagation, other materials may be added to reduce weight, improve fire resistance, pigments are added to obtain the desired part color and to improve UV resistance.

In pultrusion, the impregnation of the reinforcing fibers with liquid resin forms the basis of every pultrusion process. An injection box, bath, or dip bath are most commonly used to impregnate the fibers. In the dip bath process, fibers are passed over and under wet-out bars, which causes the fibers to spread and accept resin. In the injection box process, fibers pass through openings or a slot into a cavity that is filled with resin prior to entering a die. In a bath process the continuous fiber strands are dipped into a resin bath for impregnation. Forming is usually accomplished after impregnation with pre-forming fixtures commonly known as forming guides, which consolidate the reinforcing fibers and move them closer to the final shape provided by the die. Die heating is an important process control parameter as it determines the rate of reaction, the position of reaction within the die, and the magnitude of the peak exotherm. Improperly cured material will exhibit poor mechanical properties, in some cases their physical appearance may appear identical to adequately cured products, but very often there will be a visual indication of improper curing. Excess heat inputs may result in products with thermal cracks or crazes, which destroy the electrical, corrosion resistance, and mechanical properties of the composites. Excess heat may also cause the resin to harden too soon within the die and thereby damage the die or increase drag force on the part and potentially damage the part.

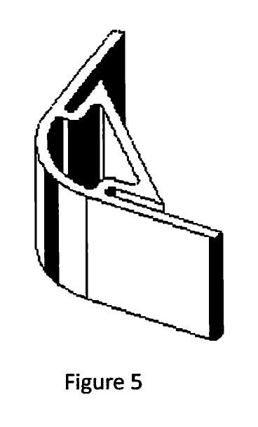

As noted above, the corner joints of a ULD can be formed by pultrusion. The inventors determined that an economical advantage could be gained by emulating lightweight aerospace grade autoclave processed carbon prepreg composite materials with a low cost composite alternative that combines a thermoset resin and carbon fiber in a pultrusion process. FIG. 5 provides one example of an applicable carbon polyurethane cross-section of a corner joints for an all polymer composite air cargo container.

The thermoset resin is selected to reduce flexure and enable axial stresses along the anisotropic carbon fiber material's primary axis. A suitable thermoset resin that can be used is polyurethane. One example of suitable polyurethane is Baydur PUL 2500, which is an isocyanate-modified diphenylmethane diisocyanate. This resin can be combined with economical carbon fibers, such as Zoltek's Panex 35 50 k continuous tow carbon fibers. The carbon fibers can be oriented in various directions in addition to the pull direction and use various fiber architectures and fabrics.

One suitable fabric is V2 Composite's 15 oz. weft triaxial that uses Toho's 24 k carbon fiber with a sizing and arranged in the 0°, 45° and −45° orientations. The sizing on a carbon fiber gives the carbon fibers desirable properties, such as improved fiber containment and reduced fiber breakage, higher strength, improved flexibility and handling, reduced fuss formation, better wet-out, and improved inter-laminar bonding. In additional embodiments, sizing, such as Hydrosize's U6-01, may be selected to protect the carbon fiber during processing, improve “wet-out” performance and aid in resin/fiber bonding. The Hydrosize U6-01 sizing is a polyether soft segment aliphatic isocyanate, and their use are described in various publications including US 2004/0191514, US 2006/0204763, and US 2007/0082199, the contents of which are incorporated herein by reference in their entirety for both the disclosure of the properties and use of the U6-01 sizing, for fiber-based polymer composite materials generally, and the disclosure of pultrusion. The sizing used is a urethane emulsion or dispersion of urethane as a solid, the primary solid, or the only solid within the sizing. Reports describe the sizing as functioning as a film former around the fibers. Thus, while a U6-01 sizing has found to be particularly useful, especially with a polyurethane resin, it is expected that other film forming polymer sizings may be used with carbon fibers with a compatible resin.

A composite mat, veil, or surfacing; such as Owens Corning's BG 34 Fireblocker material, may be imbedded beneath the resin surface to improve the finished part's fire resistance. A Nexus Polyester composite veil available from Precision Fabrics Group, may be added to improve the part's surface finish and consistency, improve weatherability and corrosion, reduces fiber blooming and mold wear and improved abrasion resistance. The composite mat, veil or surfacing also may be used to modify color, surface texture, impart various material properties, and/or improve fire performance.

In certain embodiments the fiber volume fraction of carbon fiber to polyurethane for the composite ranges from about 60% to about 70%, in other embodiments from about 62% to about 68%. Higher fiber volume fractions will prevent adequate wet-out of the carbon fibers and the part will lose strength. Lower fiber volume fractions will result resin rich areas and a weak spots in the part as well as increase the potential for cracking during cooling.

The pultrusion process method is used in this application to force the resin to infiltrate into the fibers to gain a benefit similar to that of the pre-processing roller infusion of resin into carbon prepreg materials. This method also offers superior cost reduction for high volume parts.

The pultrusion members are designed to locate and orient fibers to adjust the material properties needs over the cross-section and thereby creating a tensile and compressive strength gradient is created across the parts thickness. In addition, by creating slack or tension variations in fibers entering the die during the forming process some material properties can be altered or improved. For example, the tensile modulus can be improved relative to an identical part with the only variable being fiber tension. Therefore, forming a part with some of the continuous tow carbon fiber under tension and others not an improvement in the tensile modulus will be realized.

A selection of materials that adequately stabilizes the carbon fibers to ensure strong material properties and yet allow some movement within the matrix which exploits some benefit of the elasticity within the resin and thus enables benefit from fibers out of axis and thereby yield better shear strength than some other carbon fiber composite materials.

### EXAMPLES

Sheets and more complex shapes were pultruded using Zoltek's Panex 35 50 k continuous tow carbon fibers. The carbon fibers had been previously coated with the Hydrosize's U6-01 a sizing. The sizing as previously described was selected to improve fiber wet-out, protect the fibers and improve fiber handling, reduce fuzzing, upon further application of the sizing lubricity was improved by decreasing friction during handling, material properties were also improved. It is anticipated that other urethane-based sizings may be suitable upon some amount of experimentation. The resin selected for applying during the pultrusion process is a polyurethane resin, Baydur PUL 2500. The carbon fibers were pulled from multiple spools to provide strands or bundles of carbon fibers which were fed through a sheet/panel/creel card with multiple openings to keep the various strands oriented and separated from each other improve handling of the carbon fibers and assist in wet-out. Then the fibers progress into an injection box in which the carbon fibers were infiltrated with the polyurethane resin. The resin coated fibers then pass through a heated die which cures the resin and shapes the part. For complex shapes the fibers were passed through a series of openings in multiple forming guides to increase the proximity of the fibers into a volume closer to that of which the fibers will enter the injection box or die, depending of the preferred sequence of resin infiltration. After the strands of carbon fibers had been brought into closer proximity to the final shape, the strands and face sheets were passed into the injection box and die. Resin impregnation occurs in the injection box. The heat in the die heats the polyurethane embedded between the fibers and facesheets, a shape is imparted, and the resin cured. The cured product was continuously pulled through the remainder of the die and exited the box/die as a hot, constant cross sectional product, which was cooled and then passed to a puller to cut to the desired length. The product made according to this process was tested for compression strength, tensile strength, and shear strength.

The following parameters may be controlled to optimize the performance of the pultrusion: (i) fiber volume, (ii) pull rate, (iii) die transition taper, (iv) heat, (v) injection box volume, and (vi) flow rate of the resin (vii) orientation of the fibers in the facesheet. (viii) type of facesheet.

Compression Strength Testing

Sample A was formed of unidirectional fibers (0 degrees and 90 degrees). Three specimens of Sample A at 0 degrees were tested. The three samples had the following dimensions:

TABLE 1

| Specimen No. | Width (in) | Thickness (in) | Length (in) | Area (sq in) |
|---|---|---|---|---|
| T-1 | 0.9757 | 0.1299 | 10 | 0.12674 |
| T-2 | 1.0020 | 0.1305 | 10 | 0.13076 |
| T-3 | 1.0018 | 0.1324 | 10 | 0.13264 |

Sample B was formed with fabric face sheets (0 and 90 degrees). Three specimens of Sample B at 0 degrees were tested. The three samples had the following dimensions:

TABLE 2

| Specimen No. | Width (in) | Thickness (in) | Length (in) | Area (sq in) |
|---|---|---|---|---|
| T-7 | 0.9992 | 0.1290 | 10 | 0.12890 |
| T-8 | 1.0010 | 0.1305 | 10 | 0.13063 |
| T-9 | 1.0002 | 0.1314 | 10 | 0.13143 |

Peak load, ultimate tensile strength and modulus were determined for the 0 degree material of Sample A and B. These results are provided below:

TABLE 3

| | | Ultimate | |
|---|---|---|---|
| Specimen | Peak Load | Tensile | Modulus |
| A No. | (lb) | Strength (KSI) | (MPSI) |
| T-1 | 33430.7 | 263.77 | 22.9 |
| T-2 | 29736.4 | 227.41 | 22.8 |
| T-3 | 33372.4 | 251.61 | 25.6 |
| Mean | 32179.83 | 247.60 | 23.8 |
| Std. Dev. | 2116.28 | 18.51 | 1.59 |
| % Cov | 6.58 | 7.48 | 6.68 |

TABLE 4

| | | Ultimate | |
|---|---|---|---|
| Specimen | Peak Load | Tensile | Modulus |
| B No. | (lb) | Strength (KSI) | (MPSI) |
| T-7 | 27249.5 | 211.41 | 17.7 |
| T-8 | 27304.4 | 209.02 | 18.7 |
| T-9 | 28546.1 | 217.20 | 17.9 |
| Mean | 27700.00 | 212.54 | 18.1 |
| Std. Dev. | 733.26 | 4.21 | 0.53 |
| % Cov | 2.65 | 1.98 | 2.92 |

Three specimens of Sample A at 90 degrees were tested. The three samples had the following dimensions:

TABLE 5

| Specimen No. | Width (in) | Thickness (in) | Length (in) | Area (sq in) |
|---|---|---|---|---|
| T-4 | 1.0007 | 0.1375 | 8 | 0.13760 |
| T-5 | 1.0023 | 0.1378 | 8 | 0.13812 |
| T-6 | 0.9980 | 0.1382 | 8 | 0.13792 |

Three specimens of Sample B at 90 degrees were tested. The three samples had the following dimensions:

TABLE 6

| Specimen No. | Width (in) | Thickness (in) | Length (in) | Area (sq in) |
|---|---|---|---|---|
| T-10 | 1.0013 | 0.1307 | 8 | 0.13087 |
| T-11 | 1.0012 | 0.1299 | 8 | 0.13006 |
| T-12 | 1.0013 | 0.1306 | 8 | 0.13077 |

Peak load, ultimate tensile strength and modulus were determined for the 90 degree material of Sample A and B. These results are provided below:

TABLE 7

| | | Ultimate | |
|---|---|---|---|
| Specimen | | Tensile | Modulus |
| A No. | Peak Load (lb) | Strength (KSI) | (MPSI) |
| T-1 | 1079.9 | 7.85 | 0.97 |
| T-2 | 1109.0 | 8.03 | 0.95 |
| T-3 | 1055.2 | 7.65 | 0.99 |
| Mean | 1081.37 | 7.84 | 1.0 |
| Std. Dev. | 26.94 | 0.19 | 0.02 |
| % Cov | 2.49 | 2.41 | 2.06 |

TABLE 8

| | | Ultimate | |
|---|---|---|---|
| Specimen | | Tensile | Modulus |
| B No. | Peak Load (lb) | Strength (KSI) | (MPSI) |
| T-7 | 769.0 | 5.88 | 2.64 |
| T-8 | 1037.6 | 7.98 | 3.49 |
| T-9 | 994.7 | 7.61 | 1.78 |
| Mean | 933.78 | 7.15 | 2.6 |
| Std. Dev. | 144.31 | 1.12 | 0.86 |
| % Cov | 15.45 | 15.68 | 32.43 |

Tensile Strength Testing

Three specimens of Sample A at 0 degrees were tested for tensile strength. The three samples had the following dimensions:

TABLE 9

| Specimen No. | Width (in) | Thickness (in) | Length (in) | Area (sq in) |
|---|---|---|---|---|
| C-1 | 0.5017 | 0.1312 | 5.5950 | 0.0658 |
| C-2 | 0.5020 | 0.1284 | 5.5075 | 0.0643 |
| C-3 | 0.4935 | 0.1304 | 5.5080 | 0.0642 |

Three specimens of Sample B at 0 degrees were tested for tensile strength. The three samples had the following dimensions:

TABLE 10

| Specimen No. | Width (in) | Thickness (in) | Length (in) | Area (sq in) |
|---|---|---|---|---|
| C-7 | 0.5018 | 0.1312 | 5.5000 | 0.0658 |
| C-8 | 0.5012 | 0.1292 | 5.4930 | 0.0646 |
| C-9 | 0.5020 | 0.1307 | 5.5655 | 0.0658 |

Peak load, compressive strength and modulus were determined for the 0 degree material of Sample A and B. These results are provided below:

TABLE 11

| | | Ultimate | |
|---|---|---|---|
| Specimen | | Tensile | Modulus |
| A No. | Peak Load (lb) | Strength (KSI) | (MPSI) |
| C-1 | 6589.1 | 100.20 | 2.37 |
| C-2 | 6067.5 | 94.43 | 2.76 |
| C-3 | 6423.31 | 100.02 | 2.81 |
| Mean | 6359.97 | 98.2 | 2.648 |
| Std. Dev. | 266.51 | 3.28 | 0.244 |
| % Cov | 4.19 | 3.34 | 9.23 |

TABLE 12

| | | Ultimate | |
|---|---|---|---|
| Specimen | | Tensile | Modulus |
| B No. | Peak Load (lb) | Strength (KSI) | (MPSI) |
| C-7 | 27249.5 | 211.41 | 17.7 |
| C-8 | 27304.4 | 209.02 | 18.7 |
| C-9 | 28546.1 | 217.20 | 17.9 |
| Mean | 5434.49 | 83.1 | 2.280 |
| Std. Dev. | 403.16 | 5.78 | 0.089 |
| % Cov | 7.42 | 6.95 | 3.91 |

Shear Strength Testing

Sample A was formed of unidirectional fibers (0 degrees and 90 degrees). Three specimens of Sample A at 0 degrees were tested for shear strength. The three samples had the following dimensions:

TABLE 13

| Specimen No. | Width (in) | Thickness (in) | Length (in) | Area (sq in) |
|---|---|---|---|---|
| S-1 | 0.4540 | 0.1321 | 2.9665 | 0.05997 |
| S-2 | 0.4545 | 0.1326 | 2.9675 | 0.06027 |
| S-3 | 0.4545 | 0.1331 | 2.9685 | 0.06050 |

Sample B was formed with fabric face sheets (0 and 90 degrees). Three specimens of Sample B at 0 degrees were tested for shear strength. The three samples had the following dimensions:

TABLE 14

| Specimen No. | Width (in) | Thickness (in) | Length (in) | Area (sq in) |
|---|---|---|---|---|
| S-7 | 0.4570 | 0.1319 | 2.9675 | 0.06029 |
| S-8 | 0.4575 | 0.1293 | 2.9655 | 0.05914 |
| S-9 | 0.4575 | 0.1303 | 2.9675 | 0.05960 |

Peak load, shear strength, back modulus and front modulus were determined for the 0 degree material of Sample A and B. These results are provided below:

TABLE 15

| Specimen | Peak | Shear Strength | Back Modulus | Front Modulus |
|---|---|---|---|---|
| A No. | Load (lb) | (KSI) | (KSI) | (KSI) |
| S-1 | 33430.7 | 763.5724 | 12731.8 | 570.35 |
| S-2 | 29736.4 | 815.9490 | 13538.9 | 576.04 |
| S-3 | 33372.4 | | | |
| Mean | | 13135.37 | 573.2 | 622.3 |
| Std. Dev. | | 570.72 | 4.02 | 15.09 |
| % Cov | | 4.34 | 0.70 | 2.42 |

TABLE 16

| Specimen | Peak | Shear Strength | Back Modulus | Front Modulus |
|---|---|---|---|---|
| B No. | Load (lb) | (KSI) | (KSI) | (KSI) |
| S-7 | 1000.0146 | 16589.9 | 1396.73 | 1462.16 |
| S-8 | 919.4002 | 15542.2 | 1230.32 | 1780.76 |
| S-9 | | | | |
| Mean | | 16066.07 | 1313.5 | 1621.5 |
| Std. Dev. | | 740.81 | 117.67 | 225.28 |
| % Cov | | 4.61 | 8.96 | 13.89 |

Three specimens of Sample A at 90 degrees were tested for shear strength. The three samples had the following dimensions:

TABLE 17

| Specimen No. | Width (in) | Thickness (in) | Length (in) | Area (sq in) |
|---|---|---|---|---|
| S-4 | 0.4545 | 0.1363 | 2.9695 | 0.06193 |
| S-5 | 0.4540 | 0.1344 | 2.9675 | 0.06103 |
| S-6 | 0.4535 | 0.1337 | 2.9675 | 0.06061 |

Three specimens of Sample B at 90 degrees were tested for shear strength. The three samples had the following dimensions:

TABLE 18

| Specimen No. | Width (in) | Thickness (in) | Length (in) | Area (sq in) |
|---|---|---|---|---|
| S-10 | 0.4575 | 0.1298 | 2.9700 | 0.05938 |
| S-11 | 0.4570 | 0.1299 | 2.9665 | 0.05934 |
| S-12 | 0.4575 | 0.1297 | 2.9735 | 0.05933 |

Peak load, shear strength, back modulus and front modulus were determined for the 90 degree material of Sample A and B. These results are provided below:

TABLE 19

| Specimen | Peak | Shear Strength | Back Modulus | Front Modulus |
|---|---|---|---|---|
| A No. | Load (lb) | (KSI) | (KSI) | (KSI) |
| S-4 | 467.4032 | 7545.0 | 365.54 | 930.20 |
| S-5 | 471.6192 | 7729.2 | 657.12 | 519.15 |
| S-6 | | | | |
| Mean | | 7637.12 | 511.3 | 724.7 |
| Std. Dev. | | 130.24 | 206.18 | 290.66 |
| % Cov | | 1.71 | 40.32 | 40.11 |

TABLE 20

| Specimen | Peak | Shear Strength | Back Modulus | Front Modulus |
|---|---|---|---|---|
| B No. | Load (lb) | (KSI) | (KSI) | (KSI) |
| S-10 | 909.8685 | 15321.9 | 1418.06 | 1489.18 |
| S-11 | 852.3557 | 14358.0 | 1439.40 | 1467.84 |
| S-12 | | | | |
| Mean | | 14839.93 | 1428.7 | 1478.5 |
| Std. Dev. | | 681.55 | 15.09 | 15.09 |
| % Cov | | 4.59 | 1.06 | 1.02 |

It should be understood that the method can be useful in forming simple cross-sectional configurations as well as the more complex corner joint piece. For example, walls, panels or tubes can be formed in this same manner based on the configuration of the dies selected. The walls, panels, or tubes can be used for numerous applications, such as vehicle wall panels or sections, aerospace and airplane walls, components and structures, automotive structural and lightweight carbon composite components, carbon composite recreational and sporting goods (example tennis racket handles, golf club shafts) and the like in which high strength, low weight and reduced costs of materials and manufacturing are important. The pultrusion examples provided above describe the formation of a sheet and corner cross-section of carbon fibers within a polyurethane resin. Both the sheet and corner cross-section joint were formed using a die that imparted the final shape. Similarly, a die can be fabricated to impart the shape of FIG. 5 or other complex geometry. For a cargo container, many of the components can be formed of a pultruded carbon fiber, polyurethane resin, using a compatible fiber sizing. For example, the joints and frame can be formed using these materials by pultrusion.

The inventors also have determined that a comparative part made of IM7/PEEK in a autoclave process can cost approximately $350/lb. In contrast, using the materials above the composite part costs less than $20/lb. An early material trial yielded a superior elastic modulus and shear stress and 60% of the tensile strength (over 80% of the tensile strength when comparing other carbon fibers tried w/PEEK using an autoclave process method).

While certain embodiments of a unit load carrying device have been herein shown and disclosed in detail, the disclosed embodiments are to be understood as being merely illustrative of the presently preferred embodiments of the invention and that no limitations are intended to the details of the construction or design herein shown other than as defined in appended claims.

What is claimed is:

1. A container comprising:
a plurality of polymer composite wall panels connected together by a plurality of polymer composite joints and defining at least a partially enclosed volume, wherein the plurality of polymer composite wall panels comprise a core of a first polymer composite material and a polymer composite surface layer of a second polymer composite material bonded to opposing surfaces of the core, and wherein the second polymer composite material exhibits an elastic modulus lower than that for the first polymer composite material.

2. The container of claim 1 wherein the first polymer composite material is selected from the group consisting of a carbon fiber reinforced composite material and a glass fiber reinforced composite material.

3. The container of claim 1 wherein the second polymer composite material is a polymer fiber reinforced composite material having reinforcing fibers selected from the group consisting of polyethylene, polypropylene, aramid, TEGRIS, and KEVLAR.

4. The container of claim 1 wherein the first polymer composite material is a carbon fiber reinforced composite material and the second polymer composite material is a polymer fiber reinforced composite with polypropylene reinforcing fibers.

5. The container or claim 1 wherein the first polymer composite material is a carbon fiber reinforced composite material and the second polymer composite material is a polymer fiber reinforced composite with KEVLAR reinforcing fibers.

6. The container or claim 1 wherein the first polymer composite material is a carbon fiber reinforced composite material and the second polymer composite material is TEGRIS.

7. The container of claim 1 wherein the container exhibits a weight to volume ratio ranging from about 0.6 lbs/ft³ to about 0.8 lbs/ft³.

8. The container of claim 1 wherein the container is aircraft cargo LD-3 container and exhibits a ratio of container tare weight to FAA certification load of 0.02 to about 0.03 relative to the IATA, 23rd Edition, Effective Jul. 1, 2008.

9. The container of claim 8 wherein the container exhibits a weight to volume ratio ranging from about 0.6 lbs/ft³ to about 0.8 lbs/ft³.

10. The container of claim 1 wherein the polymer composite wall panel exhibits weight ranging from about 0.1 to about 0.2 lbs/ft².

11. The container of claim 1 wherein the composite joints comprise a fiber reinforced composite material having reinforcing fibers selected from the group consisting of carbon fibers aramid fibers, KEVLAR, and glass fibers.

12. The container of claim 1 wherein the wherein the first polymer composite material is a carbon fiber reinforced composite material and the second polymer composite material is a polymer fiber reinforced composite with polypropylene reinforcing fibers, wherein the composite joints comprise carbon fiber reinforce composite material, and wherein the composite joint exhibits a fiber volume fraction ranging from about 60% to about 70%.

13. A polymer composite wall panel comprising:
a core of a first polymer composite material and a polymer composite surface layer of a second polymer composite material bonded to opposing surfaces of the core, and wherein the second polymer composite material exhibits an elastic modulus lower than that for the first composite material.

14. The polymer composite wall panel of claim 13 wherein the first polymer composite material is selected from the group consisting of a carbon fiber reinforced composite material and a glass fiber reinforced composite material.

15. The polymer composite wall panel of claim 13 wherein the second polymer composite material is a polymer fiber reinforced composite material having reinforcing fibers selected from the group consisting of polyethylene, polypropylene, aramid, TEGRIS, and KEVLAR.

16. The polymer composite wall panel of claim 13 wherein the first polymer composite material is a carbon fiber reinforced composite material and the second polymer composite material is a polymer fiber reinforced composite with polypropylene reinforcing fibers.

17. The polymer composite wall panel of claim 13 wherein the polymer composite wall panel exhibits weight ranging from about 0.1 to about 0.2 lbs/ft².

18. The polymer composite wall panel of claim 13 wherein the configuration of core composite material is a carbon fiber reinforced composite material and is bonded on both sides by the second composite material is a polymer fiber reinforced composite with polypropylene reinforcing fibers has higher impact strength than a aluminum sheet of similar weight.

19. The polymer composite wall panel of claim 13 wherein the first composite material is a carbon fiber reinforced composite material and the second composite material is a polymer fiber reinforced composite with KEVLAR reinforcing fibers.

20. The polymer composite wall panel of claim 13 further comprising alternating layers of first polymer composite material and second polymer composite material.

21. A method for making a composite part comprising the steps of:
in a continuous process, pulling carbon fibers coated with polyether soft segment aliphatic isocyanate sizing through a supply of polyurethane to provide polyurethane impregnated carbon fibers; and
shaping the polyurethane impregnated carbon fibers to a predetermined size and forming a carbon fiber reinforced polyurethane material, wherein the fiber volume fraction ranges from about 60% to about 70%.

22. A substantially polymer composite container comprising:
a plurality of polymer composite wall panels comprising carbon fibers joined together by a plurality of polymer composite joints comprising carbon fibers and defining at least a partially enclosed volume, the polymer composite wall panels and joints being positioned on a polymer composite base; and
one or more mechanical fasteners to retain the wall panels to the joints and the joints to the base,
wherein the substantially polymer composite container has a weight reduction of at least 50% in comparison to an aluminum container of a similar dimension and volume.

23. The substantially polymer composite container of claim 22, wherein the mechanical fasteners comprise one or more of bolts, screws and rivets.

24. The substantially polymer composite container of claim 22, wherein the mechanical fasteners comprise a metal material.
